(19) United States
(12) Patent Application Publication
(10) Pub. No.: US 2018/0278828 A1
(43) Pub. Date: Sep. 27, 2018

(54) Camera Module and Image Sensing Method Thereof, and Recording Medium Having Recorded Therein Program for Implementing Method

(71) Applicant: LG Innotek Co., Ltd., Seoul (KR)

(72) Inventor: Young Seop Moon, Seoul (KR)

(21) Appl. No.: 15/537,784

(22) PCT Filed: Dec. 15, 2015
(86) PCT No.: PCT/KR2015/013751

§ 371 Date: Jun. 19, 2017

(30) Foreign Application Priority Data
Dec. 18, 2014 (KR) 10-2014-0183339

(51) Int. Cl. H04N 5/232; H04N 5/357; G02B 7/34; H04N 5/06

(52) U.S. Cl. CPC H04N 5/23212; H04N 5/06; G02B 7/346; H04N 5/3575

(57) ABSTRACT

A camera module according to an embodiment includes an image sensor for transmitting, as an electrical image signal, a first image signal obtained from an image detection pixel and a second image signal obtained from at least one pair of phase-difference detection pixels; and an image reproduction unit for distinguishably extracting the first and second image signals from the electrical image signal, reproducing a composite image signal from the extracted first image signal, and extracting a focus value from the extracted second image signal, wherein the image sensor transmits, for each unit period of a vertical synchronization signal, the second image signal during an interval where the generation of a horizontal synchronization signal is completed.

### TECHNICAL FIELD

Embodiments relate to a camera module and an image sensing method therefor, and a recording medium having recorded therein a program for implementing the method.

### BACKGROUND ART

Generally, the camera module functions to capture an image of an object and to process the captured image such that the captured image may be displayed. To this end, the camera module may include an image sensor for capturing an image and an image reproduction unit for processing the image captured by the image sensor.

In addition, the camera module may also perform a function of automatically adjusting the focus of a lens used to photograph the object. To focus the lens, the image sensor may include a phase-difference detection pixel and an image detection pixel. The phase-difference detection pixel is a pixel used to focus the camera module, and the image detection pixel is a pixel containing information on a captured image of the object.

Various logic units for estimating a focus value used for adjusting the focus value in the phase difference extracted from an optical signal acquired from the phase-difference detection pixel are built in the image sensor. When various logic units are present within the image sensor, noise may be generated in the image sensor or performance may be degraded due to heat generated from the corresponding logic units. This phenomenon may become more serious in a camera module with higher resolution.

### DISCLOSURE

### Technical Problem

Embodiments provide a camera module having improved performance, an image sensing method thereof, and a recording medium having recorded therein a program for implementing the method.

### Technical Solution

In one embodiment, a camera module may include an image sensor configured to transmit a first image signal acquired from an image detection pixel and a second image signal acquired from at least one pair of phase-difference detection pixels as an electrical image signal, and an image reproduction unit configured to distinguishably extract the first and second image signals from the electrical image signal, reproduce a composite image signal from the extracted first image signal, and extract a focus value from the extracted second image signal, wherein the image sensor transmits the second image signal during an interval in which generation of a horizontal synchronization signal is completed in every unit period of a vertical synchronization signal.

The image sensor may include a light receiving unit configured to receive an optical signal on an object, a phase difference arrangement unit configured to identify whether the optical signal has been acquired from the image detection pixel or the phase difference detection pixels and to extract and arrange a phase difference from the optical signal acquired from the phase difference detection pixels, a timing generation unit configured to configure the optical signal acquired from the image detection pixel so as to fit to a composite image signal, and an output unit configured to output the configured composite image signal corresponding to each of the first and second image signals and the arranged phase difference as the electrical image signal, wherein the output unit may transmit the second image signal during the interval in which generation of the horizontal synchronization signal is completed in every unit period of the vertical synchronization signal.

The image sensor may further include an image processing unit configured to remove noise included in the optical signal. The image processing unit may multiply the optical signal from which the noise has been removed by a predetermined gain and output the multiplied optical signal.

The optical signal from which the noise is removed by the image processing unit may be output to the phase difference arrangement unit. Alternatively, the optical signal from which the noise is removed by the image processing unit may be output to the timing generation unit.

The phase difference arrangement unit may extract the phase difference from the optical signal received by the light receiving unit or provide the optical signal from which the noise has been removed by the image processing unit to the timing generation unit.

The phase difference arrangement unit may control the timing generation unit or image processing unit to provide the optical signal from which the noise has been removed by the image processing unit to the timing generation unit.

The timing generation unit may receive the vertical synchronization signal and the horizontal synchronization signal provided from an outside of the image sensor and supply the vertical synchronization signal and the horizontal synchronization signal to the output unit. Alternatively, the timing generation unit may generate the vertical synchronization signal and the horizontal synchronization signal.

The image processing unit may include a CDS circuit configured to remove the noise included in the optical signal.

The image processing unit may perform gamma processing or clamp processing on the optical signal.

The light receiving unit may convert the optical signal into a digital form.

The image reproduction unit may include a timing processing unit configured to distinguishably extract the first and second image signals from the electrical image signal received from the image sensor and to reproduce the composite image signal from the extracted first image signal to configure a screen, a phase difference processing unit configured to extract the focus value from the second image signal extracted by the timing processing unit, and a main controller configured to perform image processing on the configured screen and to control a focus of the optical signal using the extracted focus value.

The horizontal synchronization signal and the vertical synchronization signal may be used in reproducing the composite image signal on a frame-by-frame basis.

The image sensor may include the image detection pixel and the phase-difference detection pixels in a matrix form, wherein the horizontal synchronization signal and the vertical synchronization signal may be used in selecting a desired one of the pixels in the matrix form.

The camera module may further include an optical unit configured to generate the optical signal, and a drive unit configured to control the optical unit using the focus value.

In another embodiment, an image sensing method implemented by an image sensor of a camera module including the image sensor and an image reproduction unit, the image sensing method may include receiving an optical signal on an object, checking whether the received optical signal has been acquired from an image detection pixel or a phase-difference detection pixel, configuring the acquired optical signal to fit a composite image signal when the received optical signal has been acquired from the image detection pixel, extracting and arranging a phase difference from the acquired optical signal when the received optical signal has been acquired from the phase-difference detection pixel, and transmitting the composite image signal to the image reproduction unit during an interval in which a horizontal synchronization signal is generated in every unit period of a vertical synchronization signal, and transmitting the arranged phase difference to the image reproduction unit at the interval in which generation of the horizontal synchronization signal is completed in every unit period of the vertical synchronization signal.

In another embodiment, a recording medium having recorded therein a program for executing an image sensing method implemented by an image sensor of a camera module including the image sensor and an image reproduction unit may implement a function of receiving an optical signal on an object, a function of checking whether the received optical signal has been acquired from an image detection pixel or a phase-difference detection pixel, a function of configuring the acquired optical signal to fit a composite image signal when the received optical signal has been acquired from the image detection pixel, a function of extracting and arranging a phase difference from the acquired optical signal when the received optical signal has been acquired from the phase-difference detection pixel, and a function of transmitting the composite image signal to the image reproduction unit during an interval in which a horizontal synchronization signal is generated in every unit period of a vertical synchronization signal and transmitting the arranged phase difference to the image reproduction unit at the interval in which generation of the horizontal synchronization signal is completed in every unit period of the vertical synchronization signal.

### Advantageous Effects

Embodiments provide a camera module and an image sensing method thereof, and a recording medium having recorded therein a program for implementing the method according to the embodiments which may improve performance of an image sensor and provide images of a high definition and high quality without causing noise in the image sensor.

### DESCRIPTION OF DRAWINGS

FIG. 1 is a block diagram illustrating a camera module according to an embodiment.

FIG. 2 is a cross-sectional view illustrating an embodiment of an optical unit shown in FIG. 1.

FIG. 3 shows an example of pixels included in an image sensor.

FIGS. 4a and 4b illustrate phase-difference detection pixels.

FIG. 5 is a diagram schematically illustrating the operation of first group pixels among the phase-difference detection pixels.

FIG. 6 is a block diagram illustrating an embodiment of the image sensor shown in FIG. 1.

FIG. 7 is a block diagram illustrating another embodiment of the image sensor shown in FIG. 1.

FIG. 8 is a block diagram illustrating an embodiment of the image reproduction unit shown in FIG. 1.

FIGS. 9 to 11 illustrate a procedure of checking whether an object is focused on by a lens by using a focus value extracted from a second image signal output from an image sensor.

FIG. 12 is a flowchart illustrating an image sensing method of a camera module according to an embodiment.

FIG. 13 is waveform diagrams of various signals for explaining an image sensing method implemented in an image sensor according to an embodiment.

FIG. 14 is waveform diagrams of various signals for explaining an image sensing method implemented in an image sensor according to a comparative example.

### BEST MODE

Hereinafter, embodiments will be described in detail with reference to the accompanying drawings. However, the embodiments may be modified into various other forms, and the scope of the disclosure should not be construed as being limited to the embodiments described below. The embodiments are provided to enable those skilled in the art to more fully understand the present disclosure.

It is also to be understood that the terms “first” and “second”, “on”/“upper”/“above” and “under”/“lower”/“below” and the like used below do not require or imply any physical or logical relationship or order between such entities or elements, and may be used only to distinguish one entity or element from another entity or element.

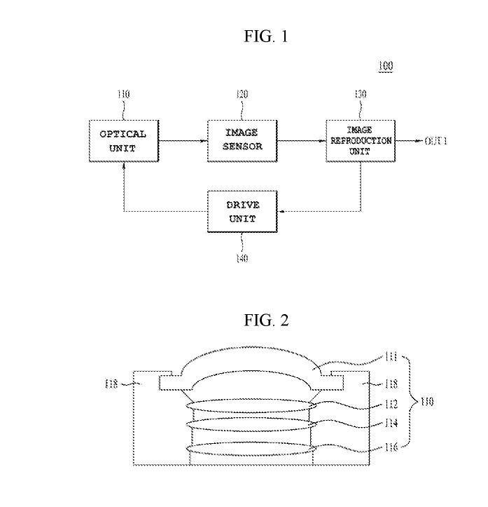

FIG. 1 is a block diagram illustrating a camera module 100 according to an embodiment.

Referring to FIG. 1, the camera module 100 according to an embodiment may include an optical unit 110, an image sensor 120, an image reproduction unit 130, and a drive unit 140.

The optical unit 110 may include a plurality of lenses. The optical unit 110 may absorb light incident from outside in order to acquire an image of an object, and output the absorbed light as an optical signal to the image sensor 120.

FIG. 2 is a cross-sectional view illustrating an embodiment of the optical unit 110 shown in FIG. 1.

Referring to FIG. 2, the optical unit 110 may include a plurality of lenses 111, 112, 114, and 116, and a lens body tube (or, lens barrel) 118. Although it is illustrated that only four lenses 111, 112, 114, and 116 are disposed in the lens barrel 118, embodiments are not limited thereto. That is, according to another embodiment, more or less than four lenses may be disposed in the lens barrel 118.

The plurality of lenses 116, 114, 112, and 111 may be disposed with being sequentially stacked on the image sensor 120. In addition, at least one of the lenses 111, 112, 114, or 116 may function to concentrate light on the image sensor 120. The plurality of lenses 111, 112, 114, and 116 may attract a large amount of light from one point of the object and refract the incident light such that the attracted light may be concentrated at one point. The light concentrated at one point by the plurality of lenses 111, 112, 114, and 116 may cause one image to be focused. When one image is formed by light concentrated at one point on the image sensor 120, it may be said that the object is at a focal distance of a lens.

Although not shown, spacers may be further disposed between the lenses 111, 112, 114, and 116. The spacers serve to maintain spaces between the lenses 111, 112, 114, and 116 by spacing the lenses 111, 112, 114, and 116 apart from each other.

The lens barrel 118 may have a cylindrical planar shape or rectangular planar shape, but embodiments are not limited thereto. The lens barrel 118 is fixedly disposed at a specific position in the optical portion 110. The lens barrel 118 may be immovably fixed for focusing.

Meanwhile, the image sensor 120 may transmit a first image signal acquired from an image detection pixel and a second image signal acquired from at least one pair of phase-difference detection pixels to the image reproduction unit 130 as electrical image signals.

According to an embodiment, the period during which the image sensor 120 transmits the second image signal may include an interval in which generation of a horizontal synchronization signal is completed in every unit period of a vertical synchronization signal. That is, the second image signal may be transmitted from the image sensor 120 to the image reproduction unit 130 in the blank interval of the vertical synchronization signal, which is the last part of each frame in which generation of the horizontal synchronization signal is completed in every unit period of the vertical synchronization signal.

Here, the horizontal synchronization signal and the vertical synchronization signal may be signals used to reproduce a composite image signal on a frame-by-frame basis. Alternatively, when the image sensor 120 includes image detection pixels and phase-difference detection pixels in the form of a matrix, the horizontal synchronization signal and the vertical synchronization signal may be signals used to select a desired pixel among the pixels in a matrix form. Here, the composite image signal may refer to a broadcast signal, for example, a TV signal for television broadcasting, and may mean a signal having both image information and audio information.

The image sensor 120 may include an image sensor for receiving an optical signal for an image of an object incident through the lens of the optical unit 110 and converting the received optical signal into an electrical image signal. For example, the image sensor of the image sensor 120 may be a charge-coupled device (CCD) sensor or a complementary metal-oxide-semiconductor (CMOS) sensor.

Hereinafter, the image detection pixels and phase-difference detection pixels of the image sensor 120 will be described with reference to the accompanying drawings.

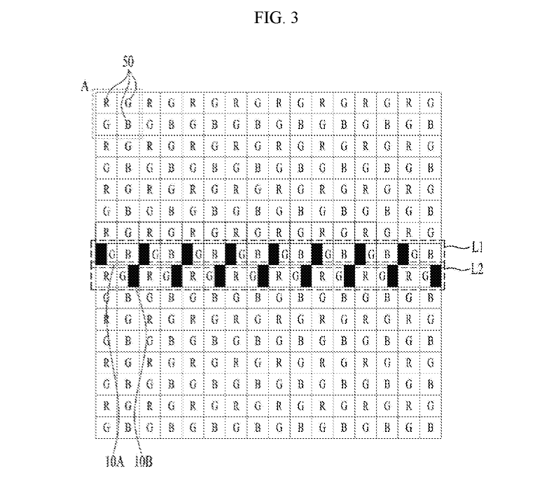

FIG. 3 shows an example of pixels included in the image sensor 120.

FIG. 3 is merely one example for explaining pixels included in the image sensor 120, embodiments are not limited to the number of or arrangement of pixels included in the image sensor 120.

The image sensor 120 may include a plurality of pairs of phase-difference detection pixels 10A and 10B and a plurality of image detection pixels 50.

The image detection pixels 50 may serve to convert an optical image signal for a photographed object into an electrical image signal. The image detection pixels 50 may be arranged in a grid pattern type in which a grid unit A is repeated, the grid unit A being implemented by a plurality of color pixels. The color image detection pixel 50 may include red (R), green (G), and blue (B), but the embodiments are not limited thereto.

In the example of FIG. 3, the grid unit A may be a Bayer arrangement in which four pixels are arranged in two rows and two columns, but the grid unit A constituting the grid pattern may be an arrangement in three rows and three columns or in four rows and four columns, but the embodiments are not limited thereto.

When the image detection pixels 50 are repeated in the grid unit A of two rows and two columns to form a grid pattern, two pixels diagonally facing each other among the four pixels constituting the grid unit A may be G pixels, and the R and B pixels may be arranged at the remaining two pixel positions, respectively.

The phase-difference detection pixels 10 may be disposed at the G pixel positions in the grid unit A of the image detection pixels 50. For example, among the phase-difference detection pixels 10A and 10B, first group pixels 10A may be arranged spaced apart from each other by a predetermined distance along a first array line L1 in a row direction, and second group pixels 10B may be arranged spaced apart from each other by a predetermined distance along a second array line L2 in the row direction. The first array line L1 and the second array line L2 may be arranged alternately in a column direction. However, the arrangement of the phase-difference detection pixels 10A and 10B shown in FIG. 3 is merely one example, and embodiments are not limited to a specific arrangement of the phase-difference detection pixels 10A and 10B in the image sensor 120. That is, the spacing between the pixels included in each of the first and second group pixels 10A and 10B or the relative arrangement type of the first group pixel 10A and the second group pixel 10B may vary.

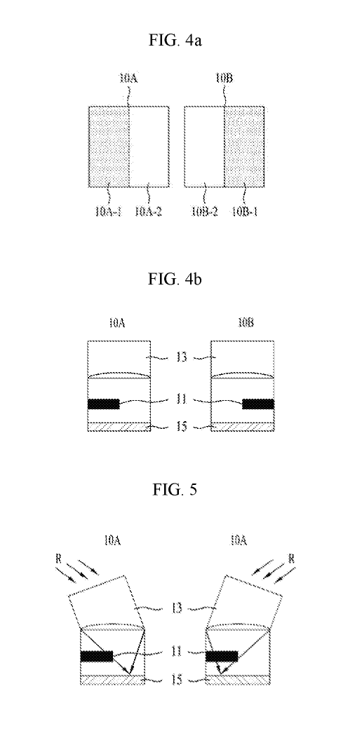

FIG. 4a is a plan view of one embodiment of the phase-difference detection pixels 10A and 10B.

The phase-difference detection pixels 10A and 10B may have a limited light receiving region in which a part of the vertically divided areas of the aperture region of each pixel is shielded. Here, the shielded portions 10A-1 and 10B-1 of the phase-difference detection pixels 10A and 10B may be arranged to be biased in different directions.

For example, the phase-difference detection pixels 10A and 10B may include a first group pixel 10A in which the shielded area is biased to the left and a second group pixel 10B in which the shielded area is biased to the right.

FIG. 4b is a diagram schematically illustrating configuration of the phase-difference detection pixels 10A and 10B.

The phase-difference detection pixel 10A, 10B may include a mask layer 11, a microlens 13, and a photodiode 15.

The mask layer 11 may form a shield area in the phase-difference detection pixel 10A, 10B. The mask layer 11 may be formed of a metal mask, and by the mask layer 11 the phase-difference detection pixel 10A, 10B may be divided into an aperture region through which light is incident and a shield region that blocks light. For example, the amount of light incident on the photodiode 15 of the image sensor 120 may be adjusted according to the area shielded by the mask layer 11.

The microlens 13 may concentrate the incident optical signal at the center portion of the phase-difference detection pixel 10A, 10B and transmit the optical signal to the photodiode 15. The relational position of the microlens 13 may be changed with respect to the photodiode 15 in order to concentrate the incident optical signal on the phase-difference detection pixel 10A, 10B. The photodiode 15 may convert the incident optical signal into an electrical signal.

Referring to FIG. 4b, light incident on each of the first group pixel 10A and the second group pixel 10B is concentrated through the microlens 13 and the light concentrated by the lenses 130 is transmitted as a light signal to the respective photodiodes 15 through the light-receiving regions where the mask layer 11 is not arranged. Thereby, a pair of images for phase difference detection may be acquired.

Although FIGS. 4a and 4b show one embodiment of the phase-difference detection pixels 10A and 10B, embodiments of the phase-difference detection pixels 10A and 10B are not limited thereto. That is, according to another embodiment, this embodiment may also be applied to other types of phase-difference detection pixels in which a part of the horizontally divided areas of the aperture portion of the pixel is shielded.

FIG. 5 is a diagram schematically illustrating the operation of first group pixels 10A among the phase-difference detection pixels.

Referring to FIG. 5, when the region biased to the left in the phase-difference detection pixel 10A is shielded, the microlens 13 may be moved to focus the light R incident from the left side of the phase-difference detection pixel 10A to the center of the image sensor 120. At this time, the light concentrated by the microlens 13 is biasedly corrected to the right side of the photodiode 15 included in the phase-difference detection pixel 10A. At this time, most of the incident light may reach the photodiode 15 without being blocked since the shield area is biased away from the direction in which light is incident, that is, biased to a direction to which light is not collected.

Alternatively, when the light R is incident from the right side of the phase-difference detection pixel 10A in the same phase-difference detection pixel 10A, the light being incident by the microlens 13 is biasedly collected to the left side of the photodiode 15. In this case, most of the incident light is blocked because the shielded area is biased to a direction to which the light is collected.

The second image signal among the electrical image signals output from the image sensor 120 may include image information acquired by processing the optical signal acquired from the phase-difference detection pixel 10A belonging to the first group pixels and image information acquired by processing the optical signal acquired from the phase-difference detection pixel 10B belonging to the second group pixels. The second image signal may include a phase difference extracted from the image information of the two phase-difference detection pixels 10A and 10B.

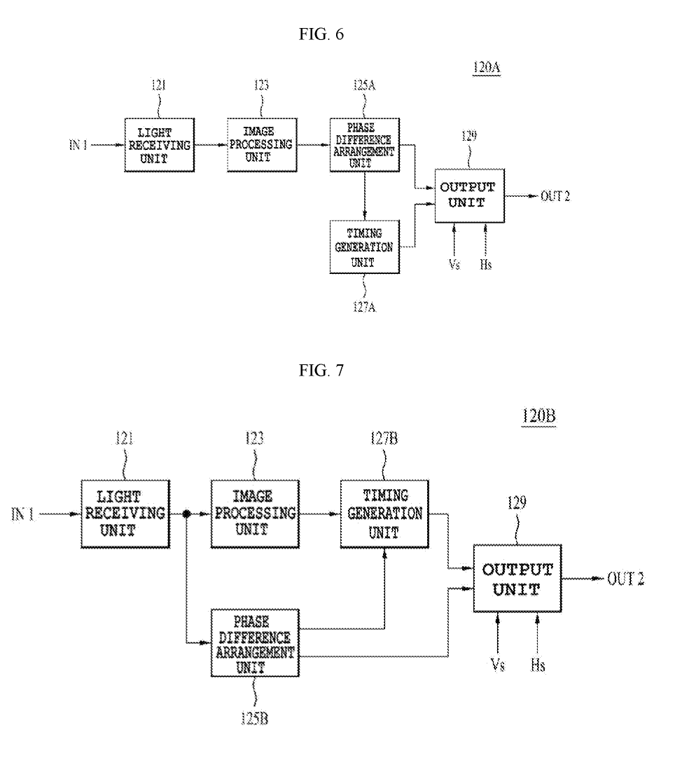

FIG. 6 is a block diagram illustrating an embodiment 120A of the image sensor 120 shown in FIG. 1.

The image sensor 120A shown in FIG. 6 may include a light receiving unit 121, an image processing unit 123, a phase difference arrangement unit 125A, a timing generation unit 127A, and an output unit 129.

The light receiving unit 121 receives an optical signal on an object from the optical unit 110 via the input terminal IN1. The light receiving unit 121 may convert the optical signal into a digital form and output image data of the conversion result. For simplicity, the image data is referred to as an “optical signal.”

The image processing unit 123 may remove noise included in the raw optical signal received from the light receiving unit 121 and output the result of removing the noise to the phase difference arrangement unit 125A. To this end, the image processing unit 123 may include a correlated double sampling (CDS) circuit.

In addition, the image processing unit 123 may multiply the optical signal from which noise has been removed by a predetermined gain, and output the optical signal whose level is adjusted by gain multiplication to the phase difference arrangement unit 125A. To this end, the image processing unit 123 may include an auto gain control (AGC) circuit.

The image processing unit 123 may further perform gamma processing or clamp processing.

In this way, the image processing unit 123 may process the optical signal output from the light receiving unit 121, and output the processed optical signal to the phase difference arrangement unit 125A.

In some cases, the image processing unit 123 may be omitted from the image sensor 120. In this case, the optical signal output from the light receiving unit 121 may be provided to the phase difference arrangement unit 125A.

The phase difference arrangement unit 125A identifies whether the optical signal processed by the image processing unit 123 has been acquired from the image detection pixels (for example, reference numeral 50 in FIG. 3) or the phase-difference detection pixels (for example, reference numeral 10A and 10B in FIG. 3). If it is determined that the optical signal has been acquired from the phase-difference detection pixels, the phase difference arrangement unit 125A extracts a phase difference from the optical signal, arrange the extracted phase difference, and outputs a result of the arrangement to the output unit 129 as a second image signal. However, if it is determined that the optical signal has been acquired from the image detection pixels, the phase difference arrangement unit 125A outputs the optical signal to the timing generation unit 127A.

The timing generation unit 127A configures the optical signal received by the light receiving unit 121, processed by the image processing unit 123 and then bypassed by the phase difference arrangement unit 125A so as to fit a composite image signal, and outputs a result of the configuration to the output unit 129 as a first image signal.

The output unit 129 outputs the configured composite image signal corresponding to the first image signal and the determined phase difference corresponding to the second image signal together as an electrical image signal to the image reproduction unit 130 through the output terminal OUT2. At this time, the output unit 129 may transmit the second image signal in an interval in which generation of a horizontal synchronization signal Hs is completed in every unit period of a vertical synchronization signal Vs, namely in the last part of each frame. That is, according to an embodiment, the second image signal is inserted into the interval in which generation of the horizontal synchronization signal Hs is completed in the last part of each frame.

FIG. 7 is a block diagram illustrating another embodiment 120B of the image sensor 120 shown in FIG. 1.

The image sensor 120B shown in FIG. 7 may include a light receiving unit 121, an image processing unit 123, a phase difference arrangement unit 125B, a timing generation unit 127B, and an output unit 129. Here, the light receiving unit 121, the image processing unit 123, and the output unit 129 are identical to the light receiving unit 121, the image processing unit 123, and the output unit 129 shown in FIG. 6, respectively, and are thus assigned the same reference numeral. Redundant description is omitted.

Unlike the phase difference arrangement unit 125A shown in FIG. 6, which receives an optical signal processed by the image processing unit 123, the phase difference arrangement unit 125B shown in FIG. 7 identifies whether an optical signal received from the light receiving unit 121 has been acquired from the image detection pixels (for example, reference numeral 50 in FIG. 3) or the phase-difference detection pixels (for example, reference numerals 10A and 10B in FIG. 3).

If it is determined that the optical signal has been acquired from the phase-difference detection pixels, the phase difference arrangement unit 125B extracts a phase difference from the optical signal, arrange the extracted phase difference, and outputs a result of the arrangement to the output unit 129 as a second image signal. However, if it is determined that the optical signal has been acquired from the image detection pixels, the phase difference arrangement unit 125B may control the timing generation unit 127B to receive the optical signal processed by the image processing unit 123. Alternatively, if it is determined that the optical signal has been acquired from the image detection pixels unlike drawing, the phase difference arrangement unit 125B may control the image processing unit 123 such that the optical signal processed by the image processing unit 123 is output to the timing generation unit 127B.

The timing generation unit 127A configures the optical signal received by the light receiving unit 121 and processed by the image processing unit 123 so as to fit a composite image signal, and outputs a result of the configuration to the output unit 129 as a first image signal.

The vertical synchronization signal Vs and the horizontal synchronization signal Hs, which the output unit 129 shown in FIGS. 6 and 7 requires to transmit the first and second image signals, may be given from the outside of the image sensor 120A, 120B shown in FIGS. 6 and 7 and then supplied to the output unit 129 via the timing generation unit 127A, 127B, or may autonomously be generated by the timing generation unit 127A, 127B. Embodiments are not limited to a specific position of generating and a specific position of supplying the horizontal synchronization signal Hs and the vertical synchronization signal Vs.

Referring back to FIG. 1, the image reproduction unit 130 may distinguishably extract the first and second image signals from an electrical image signal received from the image sensor 120, reproduce a composite image signal from the extracted first image signal, and extract a focus value from the extracted second image signal.

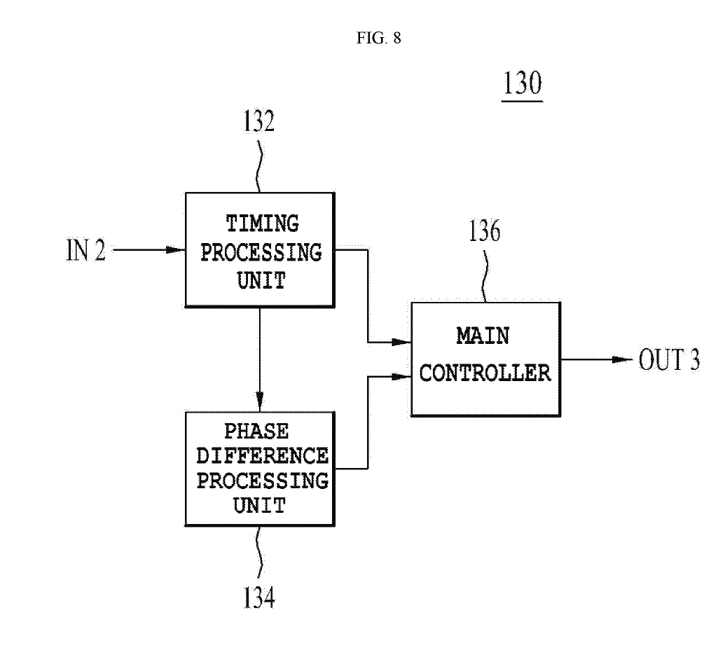

FIG. 8 is a block diagram illustrating an embodiment of the image reproduction unit 130 shown in FIG. 1.

The image reproduction unit 130 shown in FIG. 8 may include a timing processing unit 132, a phase difference processing unit 134, and a main controller 136.

The timing processor 132 receives, through the input terminal IN2, an electrical image signal output from the image sensor 120. In addition, the timing processing unit 132 distinguishably extracts first and second image signals from the received electrical image signal. Then, the timing processing unit 132 reproduces a composite image signal from the extracted first image signal to configure a screen, and outputs the result of screen configuration to the main controller 136.

Further, the timing processing unit 132 outputs the extracted second image signal to the phase difference processing unit 134. The phase difference processing unit 134 extracts a focus value from the second image signal extracted by the timing processing unit 132 and outputs the extracted focus value to the main controller 136.

The main controller 136 performs image processing on the entire screen configured by the timing processing unit 132 and outputs the entire image-processed screen to the display unit (not shown) through the output terminal OUT3. Here, the display unit, which is a part for showing the entire image-processed screen received from the main controller 136 to the user, may include a liquid crystal display (LCD) and an organic light emitting diode (OLED), but embodiments are not limited thereto.

Additionally, the main controller 136 performs an autofocus function using the extracted focus value. That is, the main controller 136 may control the focus of the optical signal using the focus value. To this end, the drive unit 140 may control the optical unit 110 in focus using the focus value output from the main controller 136 through the output terminal OUT3. The optical unit 110 may move the lenses 111, 112, 114, and 116 along the optical axis to be in focus under control of the drive unit 140.

Hereinafter, an exemplary procedure of performing focus control based on the focus value extracted by the main controller 136 and output through the output terminal OUT3 will be described with reference to the accompanying drawings.

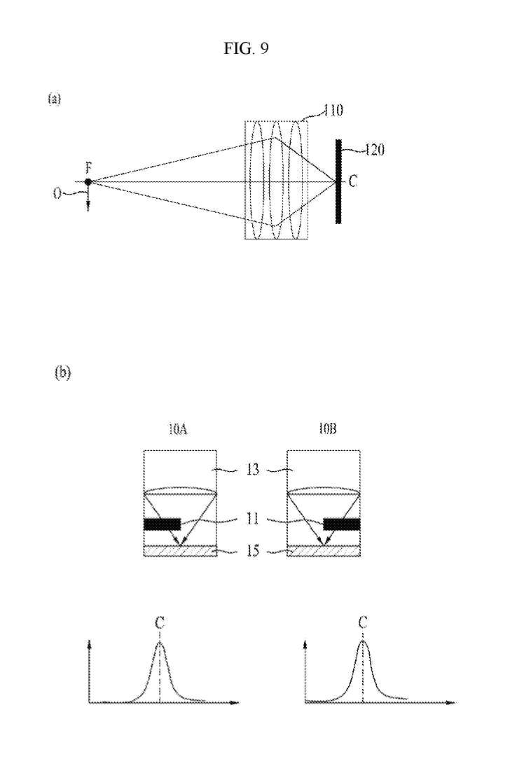

FIGS. 9 to 11 illustrate a procedure of checking whether an object is focused by a lens by using a focus value extracted from a second image signal output from an image sensor 120.

FIGS. 9(a) and 9(b) illustrate a case where an object O is positioned at the focus position F. Referring to FIG. 9(a), light transmitted from the object O through the optical unit 110 is collected in the image sensor 120. In FIG. 9(a), since the position of the object O coincides with the focus position F, the light acquired by the optical unit 110 is concentrated at a point on the image sensor 120.

FIG. 9B shows luminance distribution of optical information acquired by the phase-difference detection pixels 10A and 10B of the image sensor 120. It may be seen that distributions of the luminance values of the optical information acquired by the two phase-difference detection pixel groups 10A and 10B are the same when the object O is disposed at the focus position F as shown in FIG. 9(a).

Namely, since light is incident upon and concentrated at the center of the image sensor 120 so that the arrangement of the microlenses 13 of the phase-difference detection pixels 10A and 10B is not changed, the same optical information may be acquired regardless of the positions of the shield areas of the phase-difference detection pixels 10A and 10B. In this case, since there is no phase difference, the focus value extracted by the phase difference processing unit 134 of the image reproduction unit 130 may be represented as ‘0’. Therefore, when two images acquired from the phase-difference detection pixels 10A and 10B having different shield areas coincide with each other (i.e., when the focus value is ‘0’), it is determined that the object O is at a position F spaced apart from the camera module 100 by the focal distance of the lens.

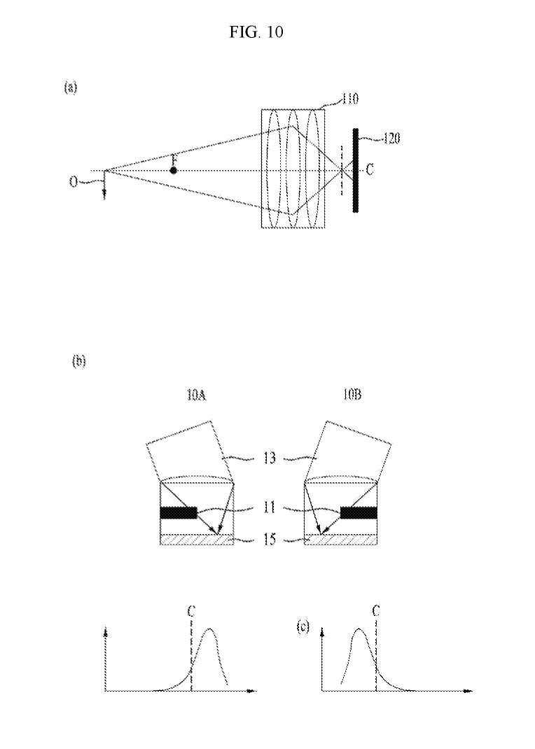

FIGS. 10(a) and 10(b) illustrate a case where the object O is located farther away from the camera module 100 than the focus position F. In this case, the image of the object O is collected and in focus at one point ahead of the position of the image sensor 120, and an image that is out of focus is formed on the image sensor 120.

Referring to FIG. 10(a), a part among the light output from the optical unit 110 which is biased to the left side (the lower side in the drawing) of the optical unit 110 is supplied to the image sensor 120 while being biased to the right side of the image sensor 120. Another part among the light from the optical unit 110 which is biased to the right side (the upper side in the drawing) of the optical unit 110 is supplied to the image sensor 120 while being biased to the left side of the image sensor 120.

For example, referring to FIG. 10(b), the microlenses 13 included in the phase-difference detection pixels 10A and 10B are moved due to the operation principle of the phase-difference detection pixels 10A and 10B described with reference to FIG. 5. At this time, the light is concentrated at the central area of the photodiode 15 due to the microlens 13 of the phase-difference detection pixel 10A, 10B. Accordingly, the luminance value of the optical signal acquired from the first group pixel 10A is high in pixels arranged on the right side of the image sensor 120, while the luminance value of the optical signal acquired from the second group pixel 10B is high in pixels arranged on the left side of the image sensor 120.

That is, as shown in FIG. 10(b), the luminance distributions of the optical signals acquired by the respective phase-difference detection pixels 10A and 10B are biased to the opposite sides with respect to the center pixel C of the image sensor 120.

Therefore, in the case of FIG. 10 (b), since the light is not collected at one point on the image sensor 120, two images that are out of focus are generated. The phase difference may be acquired from these two images, and the focus value which is information on the distance by which the object O is spaced from the optical unit 110 may be acquired from the phase difference. In this case, the main controller 136 may control the optical unit 110 through the drive unit 140 until the focus value becomes ‘0’.

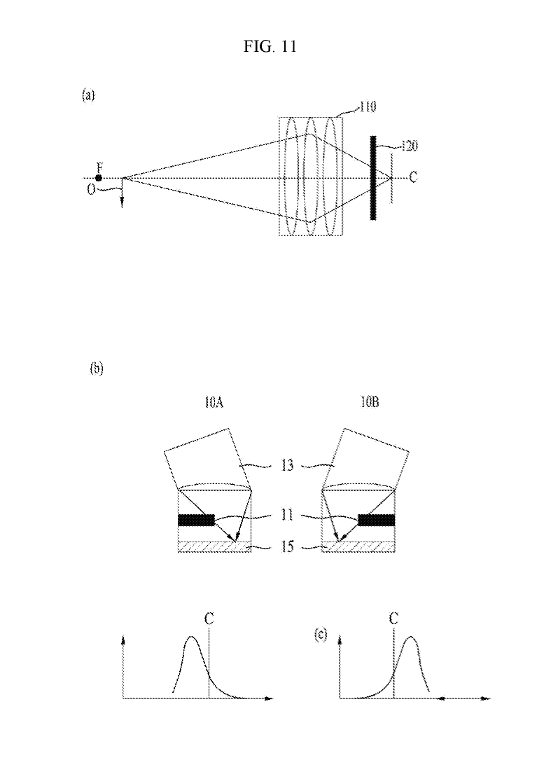

FIGS. 11(a) and 11(b) illustrate a case where the object O is closer located from the camera module 100 than the focal position F. In this case, a focused image of the object O is formed behind the position of the image sensor 120, and an image that is out of focus is formed at the position of the image sensor 120.

Referring to FIG. 11(a), a part among the light output from the optical unit 110 which is biased to the left side (the lower side in the drawing) of the optical unit 110 is supplied to the image sensor 120 while being biased to the left side of the image sensor 120. Another part among the light output from the optical unit 110 which is biased to the right side (the upper side in the drawing) of the optical unit 110 is supplied to the image sensor 120 while being biased to the right side of the image sensor 120.

Even in this case, movement of the microlenses 13 included in the phase-difference detection pixels 10A and 10B occurs as shown in FIG. 11(b). In contrast to the case of FIG. 10(b), the luminance value of the optical signal acquired from the second group pixel 10A is high in the pixels disposed on the left side of the image sensor 120 and the luminance value of the optical signal acquired from the second group pixel 10B is high in the pixels disposed on the right side of the image sensor 120.

That is, referring to FIG. 11(b), the luminance distributions of the optical signals acquired by the respective phase-difference detection pixels 10A and 10B are biased to the opposite sides with respect to the center pixel C of the image sensor 120, and show a tendency different from that of the luminance distributions of FIG. 10(b).

In addition, in the case of FIG. 11 (b), since the light is not collected at one point on the image sensor 120 as in the case of FIG. 10 (b), two images that are out of focus are generated. The phase difference between these two images may be acquired, and the focus value which is information on the distance by which the object O is spaced from the optical unit 110 may be acquired from the phase difference. In this case, the main controller 136 may control the optical unit 110 through the drive unit 140 until the focus value becomes ‘0’.

In brief, by controlling the optical unit 110 through the drive unit 140 using the focus value output from the main controller 136 through the output terminal OUT3, the focus value may converge on ‘0’.

Hereinafter, an image sensing method 200 according to an embodiment implemented by the image sensor 120 of the camera module 100 will be described with reference to the accompanying drawings.

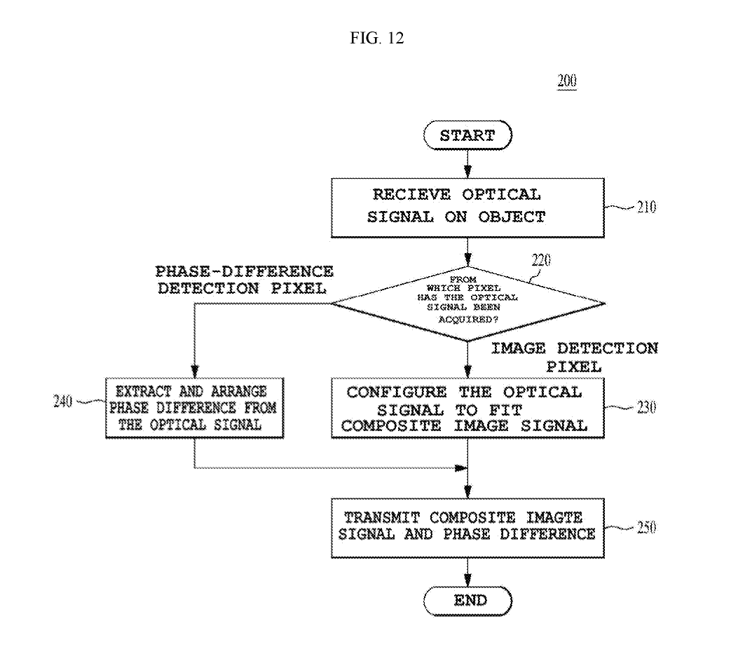

FIG. 12 is a flowchart illustrating an image sensing method 200 of a camera module according to an embodiment.

The image sensing method 200 according to an embodiment will be described with reference to FIGS. 1, 6, 7, and 12.

First, an optical signal on an object is received (step 210). Step 210 may be performed by the light receiving unit 121 shown in FIGS. 6 and 7.

After step 210, it is checked whether the received optical signal has been acquired from an image detection pixel or a phase-difference detection pixel (step 220). Step 220 may be performed by the phase difference arrangement units 125A or 125B shown in FIGS. 6 and 7.

If the received optical signal has been acquired from the image detection pixel, the acquired optical signal is configured to fit a composite image signal (step 230). Step 230 may be performed by the timing generation units 127A and 127B.

However, if the received optical signal has been acquired from the phase-difference detection pixel, the phase difference is extracted from the acquired optical signal and arranged (step 240). Step 240 may be performed by the phase difference processing units 125A and 125B.

After step 230 or 240, the composite image signal and the determined phase difference are transmitted as an electrical image signal to the image reproduction unit 130 (step 250). The step 250 may be performed by the output unit 129 shown in FIGS. 6 and 7.

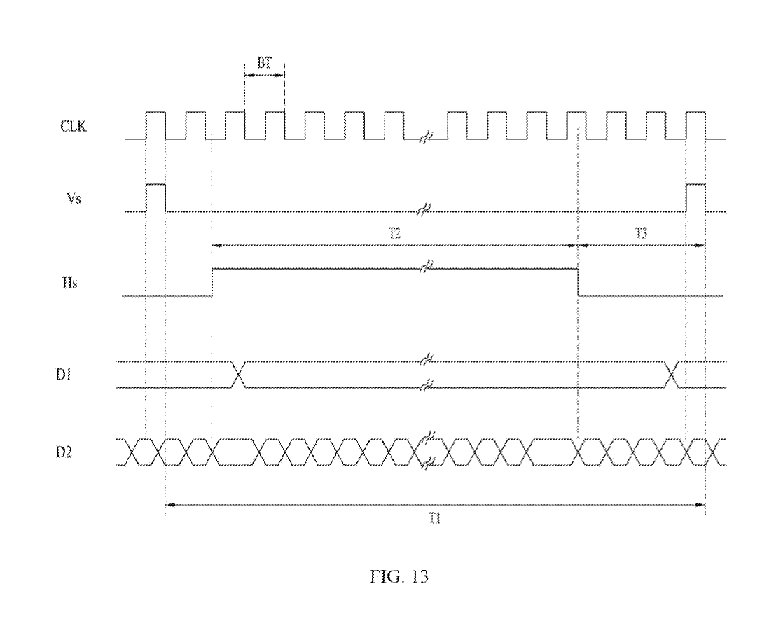

FIG. 13 is waveform diagrams of a clock signal CLK, a vertical synchronization signal Vs, a horizontal synchronization signal Hs, and first and second image signals D1 and D2 for explaining the image sensing method 200 shown in FIG. 12 implemented by the image sensor 120 shown in FIG. 6 or 7.

In FIG. 13, the clock signal CLK is a system clock signal that is used to generate the vertical synchronization signal Vs, the horizontal synchronization signal Hs, and the first and second image signals D1 and D2. While FIG. 13 illustrates that the vertical synchronization signal Vs is generated at the rising edge of the clock signal CLK and the horizontal synchronization signal Hs is generated at the logic level “Low” of the clock signal CLK, this is only one example. Embodiments are not limited to a specific trigger point or a specific logic level of the clock signal CLK at which the vertical synchronization signal Vs and the horizontal synchronization signal Hs are generated.

In addition, the clock signal CLK, the vertical synchronization signal Vs, and the horizontal synchronization signal Hs may be generated by the timing generation units 127A and 127B shown in FIGS. 6 and 7, may be generated from the timing processing unit 132 shown in FIG. 8, or may be generated outside the camera module 100. Embodiments are not limited to these sources of generation of the signals CLK, Vs, and Hs.

Referring to FIGS. 7, 8, 12 and 13, the output unit 129 transmits the composite image signal in every unit period T1 of the vertical synchronization signal Vs in response to the horizontal synchronization signal Hs. That is, while the horizontal synchronization signal Hs is generated (that is, while the horizontal synchronization signal Hs remains at the logic level “High”) (in interval T2) within the unit period T1 of the vertical synchronization signal Vs, the output unit 129 may transmit the first image signal D1 configured as a composite image signal to the image reproduction unit 130. However, while the horizontal synchronization signal Hs is not generated (i.e., while the horizontal synchronization signal Hs remains at the logic level “Low”) (in interval T3) within the unit period T1 of the vertical synchronization signal Vs, the first image signal D1 is not output from the output unit 129. Although FIG. 13 illustrates that the first image signal D1 is not output after a predetermined period of the clock signal CLK subsequent to transition of the horizontal synchronization signal Hs from the logic level “High” to the logic level “Low”, embodiments are not limited thereto. According to another embodiment, unlike FIG. 13, the output unit 129 may stop transmitting the first image signal D1 immediately after the horizontal synchronization signal Hs transitions from the logic level “High” to the logic level “Low”.

Further, the output unit 129 may transmit the arranged phase difference to the image reproduction unit 130 as the second image signal D2 in an interval within which generation of the horizontal synchronization signal Hs is ended (i.e., an interval in which the horizontal synchronization signal Hs remains at the logic level “Low”) each unit period T1 of the vertical synchronization signal Vs.

The numbers of pixels in each row and each column of a unit frame reproduced by the vertical synchronization signal Vs and the horizontal synchronization signal Hs may be 4208 and 3120, respectively. The number of unit periods BT of the clock signal CLK included in an interval T2 in which the horizontal synchronization signal Hs is generated (i.e., an interval in which the horizontal synchronization signal Hs remains at the logic level “High”) within the unit period T1 of the vertical synchronization signal Vs may be 4240. That is, the length of the interval in which the horizontal synchronization signal Hs is not generated within the unit period T1 of the vertical synchronization signal, namely the interval T3 in which the horizontal synchronization signal Hs remains at the logic level “Low”, may be a period sufficient to transmit the second image signal D2 to the image reproduction unit 130.

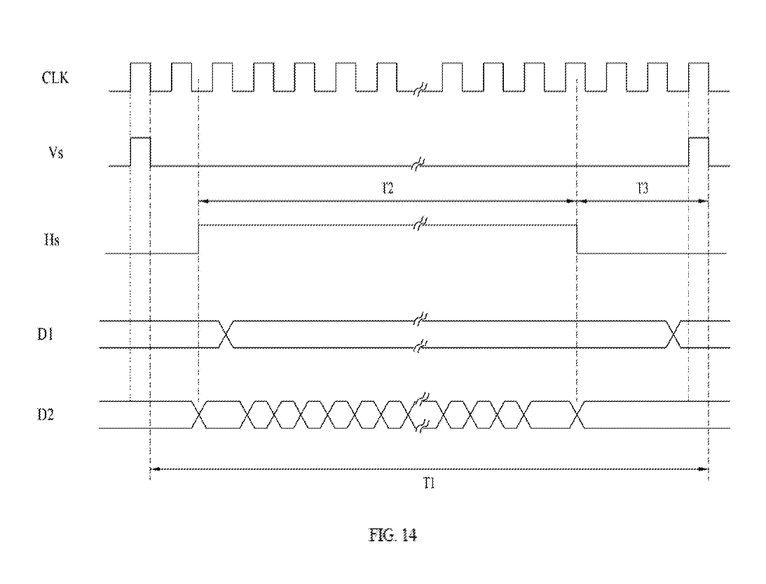

FIG. 14 is waveform diagrams of a clock signal CLK, a vertical synchronization signal Vs, a horizontal synchronization signal Hs, and first and second image signals D1 and D2 for an image sensing method implemented by an image sensor according to a comparative example.

The image sensing method implemented by the image sensor according to the comparative example may perform Operations 210, 230 and 250 without performing Operations 220 and 240 shown in FIG. 12. In this case, referring to FIG. 14, while the horizontal synchronization signal Hs is not generated (that is, while the horizontal synchronization signal Hs remains at the logic level “Low”) (in interval T3) within the unit period T1 of the vertical synchronization signal Vs, the second image signal D2 is not transmitted to the image reproduction unit 130. That is, the second image signal D2 is not inserted in the interval T3.

In addition, in the case of a camera module according to the comparative example, the phase difference processing unit 134 shown in FIG. 8 is disposed in the image sensor 120, not in the image reproduction unit 130. In this case, noise may be generated in the image sensor 120 or performance may be degraded due to heat generated from the phase difference processing unit 134. However, in the case of the camera module 100 according to the above-described embodiment, as the second image signal D2 is transmitted to the image reproducer 130 in a specific period T3, the phase difference processing unit 134 may be disposed in the image reproduction unit 130, not in the image sensor 120. Therefore, the above-described issues that may be raised when the phase difference processing unit 134 is disposed in the image sensor 120, that is, the issues of noise and performance degradation may be settled.

In addition, since the image sensor 120 transmits the second image signal D2 only during the blank period of the vertical synchronization signal Vs, transmission may not affect the high frame rate of the image sensor 120.

In addition, in the case of the camera module according to the comparative example, since the phase difference processing unit 134 is disposed in the image sensor 120, data related to the phase difference should be transmitted to the image reproduction unit 130 by I2C (Inter-Integrated Circuit) communication or SPI (Serial Peripheral Interface) communication. Therefore, I2C or SPI communication employed for other data communication may be burdened. On the other hand, in the case of the camera module according to an embodiment, the second image signal D2 is transmitted to the image reproduction unit 130 without the help of I2C or SPI communication, and therefore the burden on I2C and SPI communication may be alleviated.

A recording medium on which a program for implementing the image sensing method 200 performed by an image sensor is recorded records a programs implementing a function of causing the light receiving unit 121 to receive an optical signal on an object, a function of causing the phase difference arrangement unit 125A, 125B to check whether the received optical signal has been acquired from an image detection pixel or a phase-difference detection pixel, a function of causing, when the received optical signal has been acquired from the image detection pixel, the timing generation unit 127A, 127B to configure the acquired optical signals so as to fit a composite image signal, and a function of causing, when the received optical signal has been acquired from the phase difference the phase-difference detection pixel, the phase difference arrangement unit 125A, 125B to extract and arrange a phase difference from the acquired optical signal, and a function of causing the output unit 129 to transmit the composite image signal to the image reproduction unit 130 while a horizontal synchronization signal is generated each unit period of the vertical synchronization signal and to transmit the arranged phase difference to the image reproduction unit 130 in an interval within which generation of the horizontal synchronization signal is ended each unit period of the vertical synchronization signal. The computer may read the recording medium.

The computer-readable medium may include all kinds of recording devices in which data readable by a computer system is stored. Examples of the computer-readable medium include ROM, RAM, CD-ROM, magnetic tapes, floppy disks, and optical data storage devices and also include carrier-wave type implementation (for example, transmission over the Internet). Furthermore, as the computer-readable recording medium may be distributed to a computer system connected via a network, computer-readable code may be stored and executed according to a distributed method. Functional programs, code, and code segments for implementing the image sensing method may be easily inferred by programmers in the art to which the present disclosure pertains.

While the present disclosure has been particularly shown and described with reference to exemplary embodiments thereof, it is to be understood that the disclosure is not limited to the disclosed embodiments. It will be understood by those skilled in the art that various modifications and applications are possible without departing from the essential features of the embodiments. For example, each component specifically shown in the embodiments may be modified and implemented. It is to be understood that all changes and modifications that come within the meaning and range of equivalency of the claims are therefore intended to be embraced therein.

### MODE FOR INVENTION

The mode for carrying out the disclosure has been fully described in “Best Mode”.

### INDUSTRIAL APPLICABILITY

A camera module and an image sensing method thereof, and a recording medium having recorded therein a program for implementing the method according to embodiments may be applied to a cellular phone, a rear-view camera for vehicles, and the like.

1. A camera module, comprising:
an image sensor configured to transmit a first image signal acquired from an image detection pixel and a second image signal acquired from at least one pair of phase-difference detection pixels as an electrical image signal; and
an image reproduction unit configured to distinguishably extract the first and second image signals from the electrical image signal, reproduce a composite image signal from the extracted first image signal, and extract a focus value from the extracted second image signal,
wherein the image sensor transmits the second image signal during an interval in which generation of a horizontal synchronization signal is completed in every unit period of a vertical synchronization signal.

2. The camera module according to claim 1, wherein the image sensor comprises:
a light receiving unit configured to receive an optical signal on an object;
a phase difference arrangement unit configured to identify whether the optical signal has been acquired from the image detection pixel or the phase difference detection pixels and to extract and arrange a phase difference from the optical signal acquired from the phase difference detection pixels;
a timing generation unit configured to configure the optical signal acquired from the image detection pixel so as to fit to a composite image signal; and
an output unit configured to output the configured composite image signal corresponding to each of the first and second image signals and the arranged phase difference as the electrical image signal,
wherein the output unit transmits the second image signal during the interval in which generation of the horizontal synchronization signal is completed in every unit period of the vertical synchronization signal.

3. The camera module according to claim 2, wherein the image sensor further comprises:
an image processing unit configured to remove noise included in the optical signal.

4. The camera module according to claim 3, wherein the image processing unit multiplies the optical signal from which the noise has been removed by a predetermined gain and outputs the multiplied optical signal.

5. The camera module according to claim 3, wherein the optical signal from which the noise is removed by the image processing unit is output to the phase difference arrangement unit.

6. The camera module according to claim 3, wherein the optical signal from which the noise is removed by the image processing unit is output to the timing generation unit.

7. The camera module according to claim 6, wherein the phase difference arrangement unit extracts the phase difference from the optical signal received by the light receiving unit or provides the optical signal from which the noise has been removed by the image processing unit to the timing generation unit.

8. The camera module according to claim 7, wherein the phase difference arrangement unit controls the timing generation unit to provide the optical signal from which the noise has been removed by the image processing unit to the timing generation unit.

9. The camera module according to claim 7, wherein the phase difference arrangement unit controls the image processing unit to provide the optical signal from which the noise has been removed by the image processing unit to the timing generation unit.

10. The camera module according to claim 2, wherein the timing generation unit receives the vertical synchronization signal and the horizontal synchronization signal provided from an outside of the image sensor and supplies the vertical synchronization signal and the horizontal synchronization signal to the output unit.

11. The camera module according to claim 2, wherein the timing generation unit generates the vertical synchronization signal and the horizontal synchronization signal.

12. The camera module according to claim 3, wherein the image processing unit comprises a CDS circuit configured to remove the noise included in the optical signal.

13. The camera module according to claim 3, wherein the image processing unit performs gamma processing or clamp processing on the optical signal.

14. The camera module according to claim 2, wherein the light receiving unit converts the optical signal into a digital form.

15. The camera module according to claim 2, wherein the image reproduction unit comprises:
a timing processing unit configured to distinguishably extract the first and second image signals from the electrical image signal received from the image sensor and to reproduce the composite image signal from the extracted first image signal to configure a screen;
a phase difference processing unit configured to extract the focus value from the second image signal extracted by the timing processing unit; and
a main controller configured to perform image processing on the configured screen and to control a focus of the optical signal using the extracted focus value.

16. The camera module according to claim 1, wherein the horizontal synchronization signal and the vertical synchronization signal are used in reproducing the composite image signal on a frame-by-frame basis.

17. The camera module according to claim 1, wherein the image sensor comprises the image detection pixel and the phase-difference detection pixels in a matrix form,
wherein the horizontal synchronization signal and the vertical synchronization signal are used in selecting a desired one of the pixels in the matrix form.

18. The camera module according to claim 2, further comprising:
an optical unit configured to generate the optical signal; and
a drive unit configured to control the optical unit using the focus value.

19. An image sensing method implemented by an image sensor of a camera module including the image sensor and an image reproduction unit, the image sensing method comprising:
receiving an optical signal on an object;
checking whether the received optical signal has been acquired from an image detection pixel or a phase-difference detection pixel;
configuring the acquired optical signal to fit a composite image signal when the received optical signal has been acquired from the image detection pixel;
extracting and arranging a phase difference from the acquired optical signal when the received optical signal has been acquired from the phase-difference detection pixel; and
transmitting the composite image signal to the image reproduction unit during an interval in which a horizontal synchronization signal is generated in every unit period of a vertical synchronization signal, and transmitting the arranged phase difference to the image reproduction unit at the interval in which generation of the horizontal synchronization signal is completed in every unit period of the vertical synchronization signal.

20. A recording medium having recorded therein a program for executing an image sensing method implemented by an image sensor of a camera module including the image sensor and an image reproduction unit, the program implementing:
a function of receiving an optical signal on an object;
a function of checking whether the received optical signal has been acquired from an image detection pixel or a phase-difference detection pixel;
a function of configuring the acquired optical signal to fit a composite image signal when the received optical signal has been acquired from the image detection pixel;
a function of extracting and arranging a phase difference from the acquired optical signal when the received optical signal has been acquired from the phase-difference detection pixel; and
a function of transmitting the composite image signal to the image reproduction unit during an interval in which a horizontal synchronization signal is generated in every unit period of a vertical synchronization signal and transmitting the arranged phase difference to the image reproduction unit at the interval in which generation of the horizontal synchronization signal is completed in every unit period of the vertical synchronization signal.
